(19) United States
(12) Patent Application Publication
(10) Pub. No.: US 2023/0153733 A1
(43) Pub. Date: May 18, 2023

(54) GENERATING GREENHOUSE GAS EMISSIONS ESTIMATIONS ASSOCIATED WITH LOGISTICS CONTEXTS USING MACHINE LEARNING TECHNIQUES

(71) Applicant: International Business Machines Corporation, Armonk, NY (US)

(72) Inventors: Kumar Saurav, Bangalore (IN); Ranjini Bangalore Guruprasad, Bangalore (IN); Jagabondhu Hazra, Bangalore (IN); Manikandan Padmanaban, Bangalore (IN); Isaac Waweru Wambugu, Nairobi (KE); Ivan Kayongo, Nairobi (KE)

(21) Appl. No.: 17/526,183

(22) Filed: Nov. 15, 2021

(51) Int. Cl. G06Q 10/06; G06Q 10/08; G06Q 30/00

(52) U.S. Cl. CPC G06Q 10/06375; G06Q 10/08; G06Q 10/067; G06Q 30/018

(57) ABSTRACT

Methods, systems, and computer program products for generating GHG emissions estimations associated with logistics contexts using machine learning techniques are provided herein. A computer-implemented method includes obtaining input data related to multiple aspects of at least one logistics context; deriving contextual features from the input data by processing the input data using data profiling techniques; training at least one machine learning model related to energy consumption based on the contextual features; generating at least one energy consumption estimate attributed to at least one logistics implementation by processing data pertaining to the at least one logistics implementation using the at least one trained machine learning model; generating at least one greenhouse gas emissions estimate attributed to the at least one logistics implementation based on the at least one energy consumption estimate; and performing automated actions based on the at least one generated greenhouse gas emissions estimate.

### BACKGROUND

The present application generally relates to information technology and, more particularly, to climate-related technologies. More specifically, logistics account for an increasingly significant amount of impact on the transportation and supply chain sectors. Additionally, within the context of such sectors, greenhouse gas (GHG) emissions (e.g., scope 1 and scope 3 emissions) are dependent on multiple parameters. However, conventional emissions data management approaches typically account only for distance and weight in emission estimations, leading to inaccuracies and resource wastage.

### SUMMARY

In one embodiment of the present invention, techniques for generating GHG emissions estimations associated with logistics contexts using machine learning techniques are provided. An exemplary computer-implemented method can include obtaining multiple items of input data related to multiple aspects of at least one logistics context, and deriving one or more contextual features from the multiple items of input data by processing at least a portion of the multiple items of input data using one or more data profiling techniques. The method also includes training at least one machine learning model related to energy consumption based at least in part on the one or more contextual features, and generating at least one energy consumption estimate attributed to at least a portion of at least one logistics implementation by processing data pertaining to the at least one logistics implementation using the at least one trained machine learning model. Further, the method additionally includes generating at least one greenhouse gas emissions estimate attributed to the at least a portion of the at least one logistics implementation based at least in part on the at least one energy consumption estimate, and performing one or more automated actions based at least in part on the at least one generated greenhouse gas emissions estimate.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an exemplary embodiment of the invention;

FIG. 2 is a diagram illustrating system architecture for context-based sub-systems, according to an exemplary embodiment of the invention;

FIG. 3 is a diagram illustrating system architecture for physics-based sub-systems, according to an exemplary embodiment of the invention;

FIG. 4 is a flow diagram illustrating techniques according to an embodiment of the invention;

FIG. 5 is a system diagram of an exemplary computer system on which at least one embodiment of the invention can be implemented;

FIG. 6 depicts a cloud computing environment according to an embodiment of the present invention; and

FIG. 7 depicts abstraction model layers according to an embodiment of the present invention.

### DETAILED DESCRIPTION

As described herein, an embodiment of the present invention includes enhancing and/or modifying GHG emissions estimations associated with a logistics context based at least in part on multiple external parameters and one or more machine learning techniques. In such an embodiment, the external parameters can include spatial-temporal variations in ambient conditions (e.g., underlying weather data, temperature data, thermodynamics data, material properties information, topographic information, mileage (i.e., distance traveled per unit of fuel consumption for a given vehicle), etc.). One or more embodiments include processing and/or incorporating multiple such external factors, and deriving therefrom one or more contextual features, wherein the contextual feature(s) can include one or more driver profiles, one or more route profiles, and/or one or more vehicle profiles. Further, such an embodiment can include identifying one or more cohorts from and/or among historical data using the one or more contextual features.

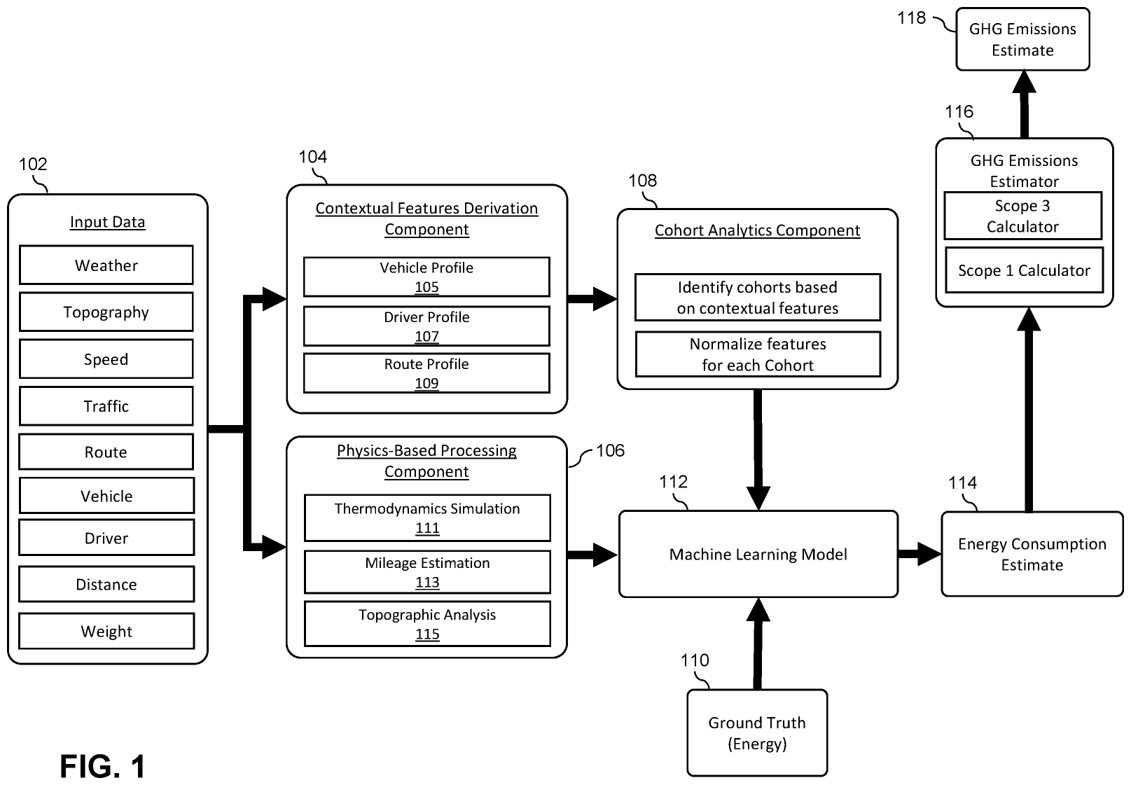

As further detailed herein, at least one embodiment also includes training at least one machine learning model to learn relationships between physics-based simulations and/or models using cohort analytics to generate an estimate of energy (e.g., fuel) consumption, and using this energy consumption estimate to generate a modified and/or enhanced GHG emissions estimate associated with a given supply chain-related transport context and/or portions thereof. In one or more embodiments, the energy consumption estimate (e.g., element 114 in FIG. 1) and the GHG emissions estimate (e.g., element 118 in FIG. 1) are not directed to any particular supply chain transport, though they can used for any type of logistics/transport. In such an embodiment, the energy consumption estimate is used to calculate the GHG emissions estimate using scope 1 and scope 3 calculators (e.g., as part of component 116 in FIG. 1). Accordingly, such an embodiment includes providing an accurate and/or corrected estimate of GHG emissions due to logistics, and an energy consumption estimate is used to calculate the GHG emissions estimate using scope 1 and scope 3 calculators.

As used herein, scope 1 emissions include direct GHG emissions that occur from sources that are controlled and/or owned by an organization (e.g., emissions associated with fuel combustion in boilers, furnaces, vehicles, etc.), and scope 3 emissions are the result of activities from assets not owned and/or controlled by a reporting organization, but that the organization indirectly impacts in its value chain. Scope 3 emissions include emissions sources not within an organization's scope 1 and scope 2 boundary. The scope 3 emissions for one organization can be, for example, the scope 1 and 2 emissions of another organization. Scope 3 emissions, also referred to as value chain emissions, often represent a majority of an organization's total GHG emissions.

FIG. 1 is a diagram illustrating system architecture, according to an embodiment of the invention. By way of illustration, FIG. 1 depicts input data 102 which can include, for example, data pertaining to weather, topography, vehicle speed, traffic, routes, vehicles, drivers, distance measures, weights, etc. Additionally, it is to be appreciated that such forms of input data are identified merely as examples, and one or more embodiments can include additional and/or different collections of input data relevant to a given implementation of the techniques detailed herein.

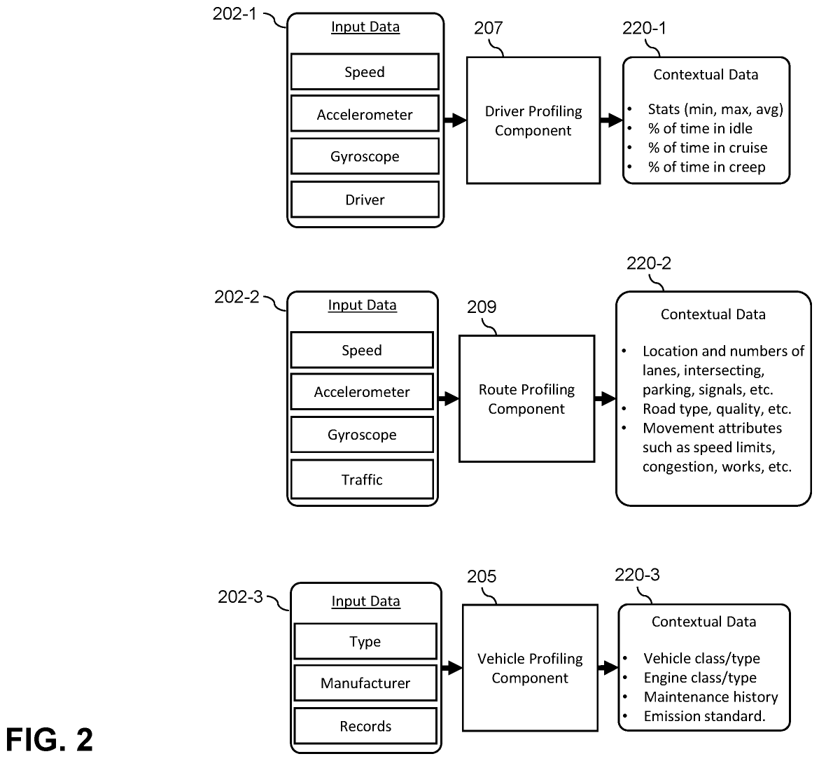

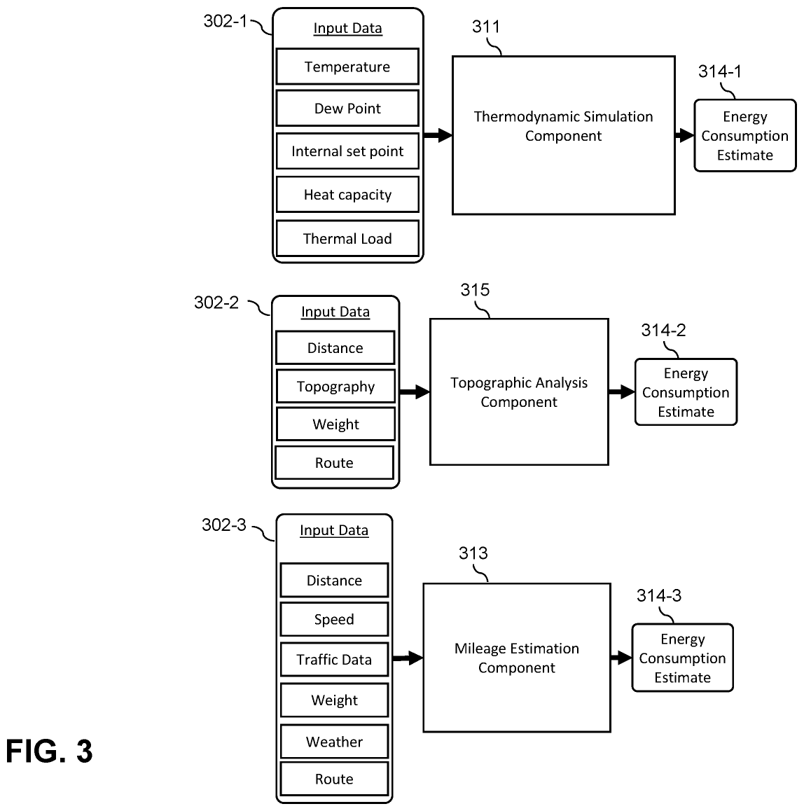

As also depicted in FIG. 1, at least a portion of input data 102 is provided to and/or processed by contextual features derivation component 104 and physics-based processing component 106. Contextual features derivation component 104, further detailed in connection with FIG. 2, processes at least a portion of input data 102 to generate at least one vehicle profile 105, at least one driver profile 107, and at least one route profile 109. Physics-based processing component 106, further detailed in connection with FIG. 3, processes at least a portion of input data 102 to generate at least one thermodynamics simulation 111, at least one mileage estimation 113, and at least one topographic analysis 115.

Outputs from contextual features derivation component 104, including contextual features such as vehicle profile 105, driver profile 107, and/or route profile 109, are provided to and/or processed by cohort analytics component 108, which identifies one or more cohorts using the contextual features. In one or more embodiments, each identified cohort represents a similar set of logistic characteristics. In such an embodiment, the cohorts are cohorts of logistics having similar features, derived using contextual features. For example, logistics with similar route profiles based on the route, topography, weather, etc., can be grouped into the same cohorts. In another example, logistics using similar fleet and driver profiles can be clustered as a cohort.

Also, cohort analytics component 108 normalizes the contextual features attributed to each cohort. Additionally, outputs from physics-based processing component 106, including data from thermodynamics simulation 111, mileage estimation 113, and/or topographic analysis 115, are provided to and/or processed by machine learning model 112, which can include, for example, at least one machine learning-based time series model (e.g., regression analysis, random forest regression, recurrent neural network (RNN)). Further, in at least one embodiment, logistic profile information associated with each of the identified cohorts from cohort analytics component 108 is processed by and/or enables the machine learning model 112 to learn one or more relationships between physics-based simulation models and/or analyses, such as provided by physics-based processing component 106.

Additionally, in one or more embodiments ground truth information 110 pertaining to relevant energy values is also provided as input to the machine learning model 112, and based at least in part on processing such input, in addition to inputs from component 106 and component 108, machine learning model 112 generates at least one energy consumption estimate 114. By way merely of illustration consider a cold supply chain example such as in connection with the transportation of perishable goods such as milk, frozen foods, etc. In such a scenario, it is important to maintain lower temperatures through a refrigeration system on the given vehicle. The energy required to maintain the temperature is proportional to the difference in transportation temperature and the ambient temperature. Therefore, energy consumption (including fuel consumption) will be lower for transportation during night because of lower ambient temperatures. As such, because daytime transportation and nighttime transportation will have different energy/fuel consumption, they should be accounted for in generating an accurate GHG emission estimate (as per one or more embodiments). In such an embodiment, the machine learning model will take the ambient temperature as one of the features, and based at least in part on the ambient temperature value, the model will determine the fuel consumption estimate (e.g., higher fuel consumption for higher ambient temperatures and lower fuel consumption for lower ambient temperatures).

Referring again to FIG. 1, the energy consumption estimate 114 is provided to and/or processed by GHG emissions estimator 116, which includes a scope 1 emissions calculator and a scope 3 emissions calculator. Based at least in part on processing the energy consumption estimate 114, the GHG emissions estimator 116 generates a GHG emissions estimate 118. Following on the cold supply chain example in the above paragraph, once the fuel consumption data is obtained from the ML model, a GHG emissions estimate can be calculated based at least in part thereon. Scope 1 and scope 3 calculators (such as in GHG emissions estimator 116) use the accurate fuel consumption estimated using the ML model and provide a corresponding GHG emissions estimate.

FIG. 2 is a diagram illustrating system architecture for context-based sub-systems, according to an exemplary embodiment of the invention. By way of illustration, FIG. 2 depicts particular sub-components of a contextual features derivation component (such as, for example, component 104 in FIG. 1). Specifically, FIG. 2 depicts input data 202-1 (which includes speed data, accelerometer data, gyroscope data, and driver data), which is provided to and/or processed by driver profiling component 207, which generates contextual data 220-1 including statistics (e.g., minimum speed values, maximum speed values, average speed values, etc.), percentage of time spent in each of multiple operating modes, including idle, cruise (i.e., greater than a given threshold for speed and acceleration), creep (i.e., less than a given threshold for speed and deceleration), etc. Accordingly, input data are analyzed by driver profiling component 207 and different contextual data are generated. For example, based on speed data, the driver profiling component 207 can calculate the maximum speed, minimum speed and the average speed of transportations. Further, using accelerometer data, the driver profiling component 207 can calculate the percentage of time spent in various modes including cruising, creeping, speeding, slowing, etc.

Additionally, FIG. 2 depicts input data 202-2 (which includes speed data, accelerometer data, gyroscope data, and traffic data), which is provided to and/or processed by route profiling component 209, which generates contextual data 220-2 including, for example, locations and numbers of lanes, locations and number of roundabouts, intersections, parking information, signals, etc., as well as road types, road quality information, etc., and movement attributes such as speed limits, congestion, construction work, etc. Accordingly, input data are analyzed by route profiling component 209 and different contextual data are generated. For example, based on speed data, route profiling component 209 can determine if the route includes highway, streets, etc. If an average speed is high during the transportation, this can indicate that a higher proportion of transportation was on highway roads. Similarly, based on traffic data, route profiling component 209 can determine if the route has/had congestion.

Further, FIG. 2 also depicts input data 202-3 (which type data, manufacturer data, and records data), which is provided to and/or processed by vehicle profiling component 205, which generates contextual data 220-3 including, for example, vehicle class and/or type information, engine class and/or type information, date of manufacture, maintenance history, list of loading weight duration within at least one trip, emission standard information, etc. Accordingly, input data are analyzed by vehicle profiling component 205 and different contextual data are generated. For example, based on type information (small/large, diesel/gasoline, road/rail/air, etc.), vehicle profiling component 205 can determine the emission(s). Similarly, based on vehicle records, vehicle profiling component 205 can determine the condition of the vehicle. For example, a vehicle with regular maintenance may provide higher mileage, and therefore lower emissions.

Additionally, in connection with each type of profiling, one or more embodiments include encoding and scaling for categorical and numerical features, respectively.

FIG. 3 is a diagram illustrating system architecture for physics-based sub-systems, according to an exemplary embodiment of the invention. As depicted in FIG. 3 and further detailed herein, each sub-system generates its own energy/fuel consumption estimate for the GHG emissions estimate. These individual energy/fuel consumption estimates and the contextual features are then processed by the machine learning model to generate a final/overall estimate of the energy/fuel consumption.

By way of illustration, FIG. 3 depicts particular sub-components of a physics-based processing component (such as, for example, component 106 in FIG. 1). Specifically, FIG. 3 depicts input data 302-1 (which includes temperature data, dew point data, internal set point data, heat capacity data, and thermal load data), which is provided to and/or processed by thermodynamic simulation component 311, which generates energy consumption estimate 314-1. Thermodynamic simulation component 311 uses one or more thermodynamic equations such as heat transfer equations, energy balance equations, and/or temperature-energy relation to generate the estimate of the fuel/energy consumption due to refrigeration. Such equations require various input data such as ambient temperature, internal temperature, set-point temperature, thermal load, etc.

Additionally, FIG. 3 depicts input data 302-2 (which includes distance data, topography data, weight data, and route data), which is provided to and/or processed by topographic analysis component 315, which generates energy consumption estimate 314-2. Topographic analysis component 315 uses topography data associated with the route to estimate the fuel/energy consumption. For example, uphill transportation of goods requires more fuel/energy than downhill transportation. The extra fuel/energy required is dependent on the topography of the route.

Further, FIG. 3 also depicts input data 302-3 (which includes distance data, speed data, traffic data, weight data, weather data, and route data), which is provided to and/or processed by mileage estimation component 313, which generates energy consumption estimate 314-3. Mileage (i.e., distance traveled per unit of fuel) is dependent on the speed of the vehicle. Further, frequent acceleration and deceleration reduces the mileage of a vehicle. Similar to these, there are many other factors (e.g., cargo weight, head/tail winds, etc.) which can affect fuel consumption. Therefore, based on such data such, fuel/energy consumption of a route can be estimated and/or calculated. Accordingly, in the example FIG. 3 embodiment, consumption estimates 314-1, 314-2, and 314-3 are separate estimates based on the individual contribution from the respective sub-systems. Each sub-system simulates different components of fuel/energy consumption. Such estimates are combined to generate a final estimate of fuel/energy consumption, and this combination can be carried out by a machine learning model (e.g., element 112 in FIG. 1), which processes the individual estimates along with corresponding contextual features.

Accordingly, one or more embodiments include using a range of features to perform simulation(s) of one or more sub-systems related to GHG emissions to identify the impact of such features on overall GHG emissions. For example, such an embodiment can include processing weather data, terrain topography, mileage analysis, etc. to perform simulation of relevant sub-systems related to GHG emissions to identify the impact of these types of data on the overall GHG emissions. Contextual features can be derived from such data and used to profile drivers, routes and vehicles associated with given supply chain transportation implementations, wherein such profiles can then be used to identify one or more data cohorts. One or more embodiments can then include using the identified cohorts to train at least one machine learning model to learn inter-relationships between physics-based simulations to provide GHG emission estimates (e.g., enhanced GHG emission estimates as compared to conventionally-generated estimates).

At least one embodiment can include combining results from physics-based simulations, augmented by cohort analytics to provide an estimate of GHG emissions pertaining to one or more supply chain transportation instances. Such an embodiment can include enhancing and/or increasing the level of accuracy of GHG emissions estimates (e.g., as compared to conventional estimate approaches) using machine learning-based estimates of relevant energy (e.g., fuel) consumption, as detailed above and herein.

By way merely of illustration, consider an example embodiment involving cold-weather supply chains, wherein temperature control is needed to transport perishable goods. Energy consumption, and thereby, emissions is dependent on the ambient conditions. On the 1^{st} order, energy consumption can be proportional to the difference in transportation temperature and the ambient temperature, as follows:

$${E}_{transport} = [ \frac{{T}_{ambient} - {T}_{t r ansport}}{R} ] ,$$

wherein R represents the thermal resistance, which is a material property which denotes how insulating a material is. Highly insulating materials have higher R values than low insulating materials.

GHG emissions will vary for different ambient conditions, and therefore, such varying conditions are accounted for in the calculation. For example, consider a first route that includes daytime transportation and an ambient temperature of 24° C., a transport temperature of 4° C., and emissions of K x (24-4)=K x 20, wherein K represents thermal conductance, which is a material property which denotes how conducting a material is. Highly conducting materials have higher K values than low conducting materials. Note also that thermal resistance is the inverse of thermal conductance (i.e., R=1/K or K=1/R). Additionally, consider a second route that includes nighttime transportation and an ambient temperature of 14° C., a transport temperature of 4° C., and emissions of K x (14-4)=K x 10.

By way of additional example, consider an embodiment wherein logistics-related transportation is carried out under foggy weather and/or heavy traffic. In such a use case, fuel consumption can be significantly increased, which will be accounted for in the calculation. For example, consider a first 100 kilometer route that includes foggy weather and limited visibility, with a maximum speed of 30 kilometers per hour (km/hr), an average speed of 21 km/hr, actual emissions of Kfx (fuel)=Kf x 12 (an example fuel consumption value), and reported emissions (using a conventional approach) of Kd x (distance)=Kd x 100. Additionally, consider a second 100 km route that includes clear weather and full visibility, with a maximum speed of 60 km/hr, an average speed of 45 km/hr, actual emissions of Kfx (fuel)=Kf x 8 (an example fuel consumption value), and reported emissions of Kd x (distance)=Kd x 100.

Accordingly, at least one embodiment can include implementing the following equation: F=∫_{source}^{destination}E(v)dx; {v=f(x)},

wherein F=fuel consumption, E=fuel economy or efficiency, v=speed, and x=position of the vehicle along the route.

One or more embodiments can also include encompassing transportation under varied topography. Transportation uphill typically requires more fuel (and generates more GHG emissions) than downhill transportation, and as such, topography of routes is included in calculation of GHG emissions estimations in such an embodiment. Consider a first example use case including a loaded vehicle travelling predominantly uphill and an empty vehicle travelling predominantly downhill, and a second example use case including a loaded vehicle travelling predominantly downhill and an empty vehicle travelling predominantly uphill. The emissions would be higher in the first use case, and one or more embodiments would include capturing such a distinction.

Accordingly, as detailed herein, at least one embodiment includes generating accurate GHG emissions estimates and/or enhanced GHG emissions estimates (as compared to conventionally-generated estimates) in connection with supply chain logistics. Such an embodiment includes capturing one or more spatio-temporal variations in ambient conditions and using underlying thermodynamics, material properties, topographic information, mileage, etc., to generate more accurate GHG emission calculations using machine learning techniques. Further, such an embodiment includes deriving contextual features from various forms of input data to profile drivers, routes and/or vehicles to identify one or more data cohorts, which can then be used to train at least one machine learning model to learn relationships between physics-based simulations to provide accurate GHG emissions estimates.

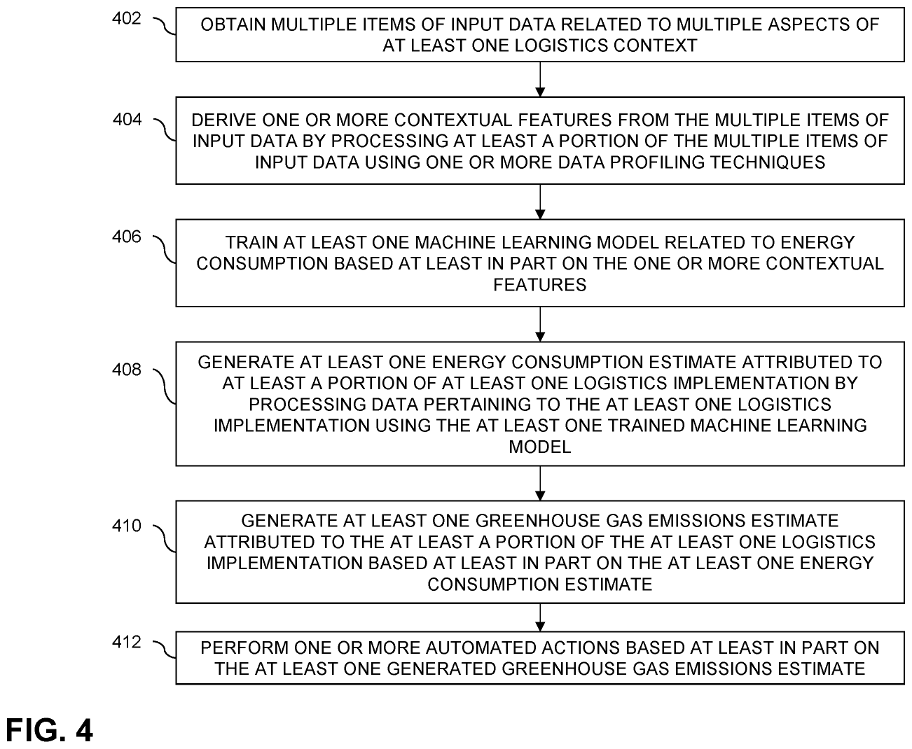

FIG. 4 is a flow diagram illustrating techniques according to an embodiment of the present invention. Step 402 includes obtaining multiple items of input data related to multiple aspects of at least one logistics context. In one or more embodiments, the multiple items of input data include two or more of weather-related data, topography-related data, speed-related data, traffic-related data, route-related data, vehicle-related data, driver-related data, distance-related data, and weight-related data.

Step 404 includes deriving one or more contextual features from the multiple items of input data by processing at least a portion of the multiple items of input data using one or more data profiling techniques. In at least one embodiment, the one or more contextual features pertain to one or more ambient conditions associated with the multiple aspects of at least one logistics context. Additionally or alternatively, deriving one or more contextual features can include generating at least one driver profile, at least one route profile, and/or at least one vehicle profile. Further, one or more embodiments can also include identifying one or more data cohorts based at least in part on the one or more contextual features.

Step 406 includes training at least one machine learning model related to energy consumption based at least in part on the one or more contextual features. In at least one embodiment, training the at least one machine learning model includes training the at least one machine learning model, using the one or more contextual features, to learn relationships between multiple physics-based simulations related to greenhouse gas emissions estimates.

Step 408 includes generating at least one energy consumption estimate attributed to at least a portion of at least one logistics implementation by processing data pertaining to the at least one logistics implementation using the at least one trained machine learning model. In one or more embodiments, generating at least one energy consumption estimate includes generating at least one estimate pertaining to fuel consumed by at least one vehicle participating in the at least one logistics implementation.

Step 410 includes generating at least one greenhouse gas emissions estimate attributed to the at least a portion of the at least one logistics implementation based at least in part on the at least one energy consumption estimate. Step 412 includes performing one or more automated actions based at least in part on the at least one generated greenhouse gas emissions estimate. In at least one embodiment, performing one or more automated actions includes modifying at least one existing greenhouse gas emissions estimate using the at least one generated greenhouse gas emissions estimate. Additionally or alternatively, performing one or more automated actions can include automatically retraining the at least one machine learning model based at least in part on the at least one generated greenhouse gas emissions estimate and resulting data from the at least one logistics implementation.

Further, in one or more embodiments, software implementing the techniques depicted in FIG. 4 can be provided as a service in a cloud environment.

It is to be appreciated that “model,” as used herein, refers to an electronic digitally stored set of executable instructions and data values, associated with one another, which are capable of receiving and responding to a programmatic or other digital call, invocation, or request for resolution based upon specified input values, to yield one or more output values that can serve as the basis of computer-implemented recommendations, output data displays, machine control, etc. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer.

The techniques depicted in FIG. 4 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 4 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

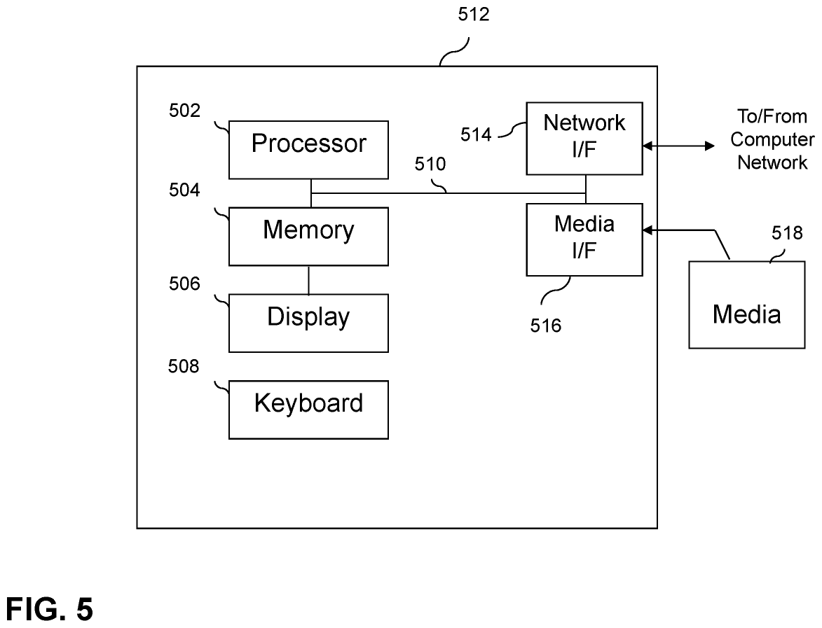

Additionally, an embodiment of the present invention can make use of software running on a computer or workstation. With reference to FIG. 5, such an implementation might employ, for example, a processor 502, a memory 504, and an input/output interface formed, for example, by a display 506 and a keyboard 508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 502, memory 504, and input/output interface such as display 506 and keyboard 508 can be interconnected, for example, via bus 510 as part of a data processing unit 512. Suitable interconnections, for example via bus 510, can also be provided to a network interface 514, such as a network card, which can be provided to interface with a computer network, and to a media interface 516, such as a diskette or CD-ROM drive, which can be provided to interface with media 518.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 502 coupled directly or indirectly to memory elements 504 through a system bus 510. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 508, displays 506, pointing devices, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 512 as shown in FIG. 5) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 502. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that implementation of the teachings recited herein are not limited to a particular computing environment. Rather, embodiments of the present invention are capable of being implemented in conjunction with any type of computing environment now known or later developed.

For example, cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

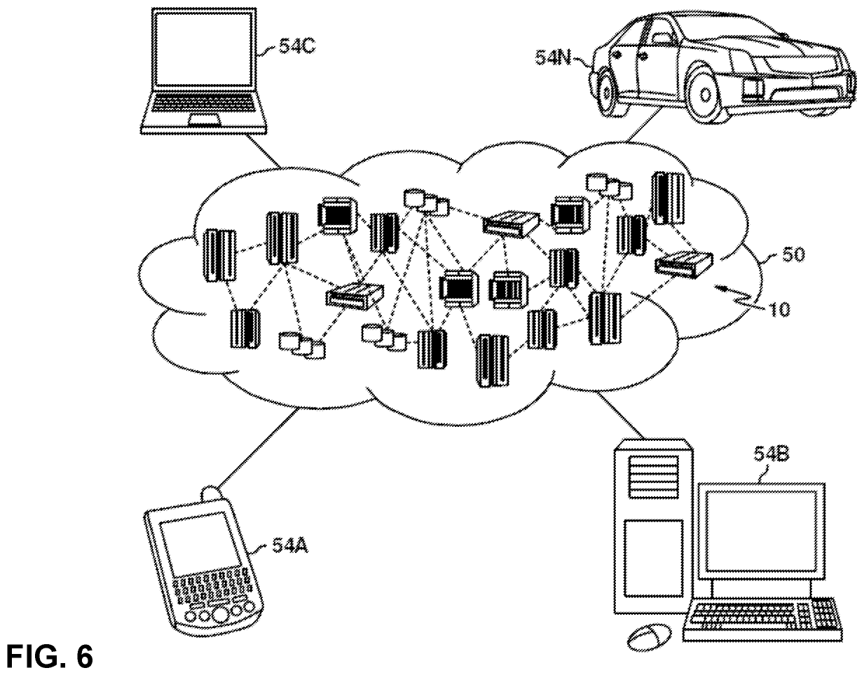

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

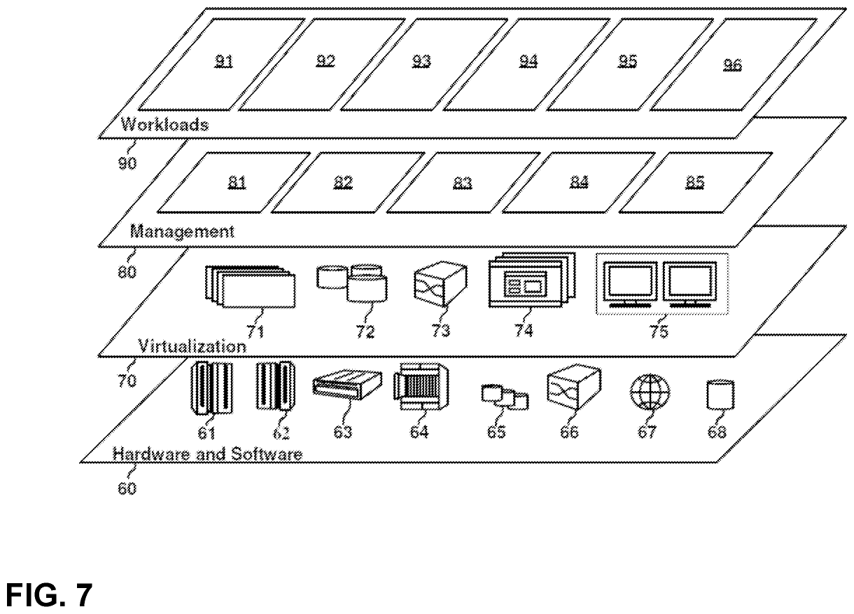

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and GHG emission estimation 96, in accordance with the one or more embodiments of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, enhancing GHG emissions estimations associated with logistics contexts using machine learning techniques.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining multiple items of input data related to multiple aspects of at least one logistics context;
deriving one or more contextual features from the multiple items of input data by processing at least a portion of the multiple items of input data using one or more data profiling techniques;
training at least one machine learning model related to energy consumption based at least in part on the one or more contextual features;
generating at least one energy consumption estimate attributed to at least a portion of at least one logistics implementation by processing data pertaining to the at least one logistics implementation using the at least one trained machine learning model;
generating at least one greenhouse gas emissions estimate attributed to the at least a portion of the at least one logistics implementation based at least in part on the at least one energy consumption estimate; and
performing one or more automated actions based at least in part on the at least one generated greenhouse gas emissions estimate;
wherein the method is carried out by at least one computing device.

2. The computer-implemented method of claim 1, wherein the one or more contextual features pertain to one or more ambient conditions associated with the multiple aspects of at least one logistics context.

3. The computer-implemented method of claim 1, further comprising:
identifying one or more data cohorts based at least in part on the one or more contextual features.

4. The computer-implemented method of claim 1, wherein deriving one or more contextual features comprises generating one or more of at least one driver profile, at least one route profile, and at least one vehicle profile.

5. The computer-implemented method of claim 1, wherein training the at least one machine learning model comprises training the at least one machine learning model, using the one or more contextual features, to learn relationships between multiple physics-based simulations related to greenhouse gas emissions estimates.

6. The computer-implemented method of claim 1, wherein generating at least one energy consumption estimate comprises generating at least one estimate pertaining to fuel consumed by at least one vehicle participating in the at least one logistics implementation.

7. The computer-implemented method of claim 1, wherein performing one or more automated actions comprises modifying at least one existing greenhouse gas emissions estimate using the at least one generated greenhouse gas emissions estimate.

8. The computer-implemented method of claim 1, wherein performing one or more automated actions comprises automatically retraining the at least one machine learning model based at least in part on the at least one generated greenhouse gas emissions estimate and resulting data from the at least one logistics implementation.

9. The computer-implemented method of claim 1, wherein the multiple items of input data comprise two or more of weather-related data, topography-related data, speed-related data, traffic-related data, route-related data, vehicle-related data, driver-related data, distance-related data, and weight-related data.

10. The computer-implemented method of claim 1, wherein software implementing the method is provided as a service in a cloud environment.

11. A computer program product comprising a computer readable storage medium having program instructions embodied therewith, the program instructions executable by a computing device to cause the computing device to:
obtain multiple items of input data related to multiple aspects of at least one logistics context;
derive one or more contextual features from the multiple items of input data by processing at least a portion of the multiple items of input data using one or more data profiling techniques;
train at least one machine learning model related to energy consumption based at least in part on the one or more contextual features;
generate at least one energy consumption estimate attributed to at least a portion of at least one logistics implementation by processing data pertaining to the at least one logistics implementation using the at least one trained machine learning model;
generate at least one greenhouse gas emissions estimate attributed to the at least a portion of the at least one logistics implementation based at least in part on the at least one energy consumption estimate; and
perform one or more automated actions based at least in part on the at least one generated greenhouse gas emissions estimate.

12. The computer program product of claim 11, wherein the one or more contextual features pertain to one or more ambient conditions associated with the multiple aspects of at least one logistics context.

13. The computer program product of claim 11, wherein the program instructions executable by a computing device further cause the computing device to:
identify one or more data cohorts based at least in part on the one or more contextual features.

14. The computer program product of claim 11, wherein deriving one or more contextual features comprises generating one or more of at least one driver profile, at least one route profile, and at least one vehicle profile.

15. The computer program product of claim 11, wherein training the at least one machine learning model comprises training the at least one machine learning model, using the one or more contextual features, to learn relationships between multiple physics-based simulations related to greenhouse gas emissions estimates.

16. The computer program product of claim 11, wherein generating at least one energy consumption estimate comprises generating at least one estimate pertaining to fuel consumed by at least one vehicle participating in the at least one logistics implementation.

17. The computer program product of claim 11, wherein performing one or more automated actions comprises modifying at least one existing greenhouse gas emissions estimate using the at least one generated greenhouse gas emissions estimate.

18. The computer program product of claim 11, wherein performing one or more automated actions comprises automatically retraining the at least one machine learning model based at least in part on the at least one generated greenhouse gas emissions estimate and resulting data from the at least one logistics implementation.

19. The computer program product of claim 11, wherein the multiple items of input data comprise two or more of weather-related data, topography-related data, speed-related data, traffic-related data, route-related data, vehicle-related data, driver-related data, distance-related data, and weight-related data.

20. A system comprising:
a memory configured to store program instructions; and
a processor operatively coupled to the memory to execute the program instructions to:
obtain multiple items of input data related to multiple aspects of at least one logistics context;
derive one or more contextual features from the multiple items of input data by processing at least a portion of the multiple items of input data using one or more data profiling techniques;
train at least one machine learning model related to energy consumption based at least in part on the one or more contextual features;
generate at least one energy consumption estimate attributed to at least a portion of at least one logistics implementation by processing data pertaining to the at least one logistics implementation using the at least one trained machine learning model;
generate at least one greenhouse gas emissions estimate attributed to the at least a portion of the at least one logistics implementation based at least in part on the at least one energy consumption estimate; and
perform one or more automated actions based at least in part on the at least one generated greenhouse gas emissions estimate.
